(19) United States
(12) Patent Application Publication
(10) Pub. No.: US 2021/0201340 A1
(43) Pub. Date: Jul. 1, 2021

(54) SYSTEM AND METHOD FOR PREDICTING DISCOUNT-DEMAND ELASTICITY

(71) Applicant: Myntra Designs Private Limited, Bangalore (IN)

(72) Inventors: Sumit Borar, Bangalore (IN); Manchit Madan, New Delhi (IN)

(21) Appl. No.: 17/247,322

(22) Filed: Dec. 7, 2020

(30) Foreign Application Priority Data
Dec. 31, 2019 (IN) 201941054585

(51) Int. Cl. G06Q 30/02; G06N 20/00; G06Q 10/08

(52) U.S. Cl. CPC G06Q 30/0206; G06Q 30/0223; G06Q 10/087; G06N 20/00

(57) ABSTRACT

System and method for predicting discount-demand elasticity of one or more retail items in a portfolio are presented. The system includes a feature engineering module configured to generate a plurality of features based on historical data of a plurality of retail items in the portfolio. The system further includes an elasticity estimator configured to estimate discount-demand elasticity values for the plurality of retail items in the portfolio; and an elasticity-band generator configured to generate a set of elasticity bands for the plurality of retail items based on the estimated discount-demand elasticity values. The system furthermore includes a training module configured to train a classification model based on the generated plurality of features and the generated set of elasticity bands. The system moreover includes an elasticity prediction module configured to generate discount-demand elasticity of the one or more retail item in the portfolio from the trained classification model.

### PRIORITY STATEMENT

The present application hereby claims priority to Indian patent application number 201941054585 filed on 31 Dec. 2019, the entire contents of which are hereby incorporated herein by reference.

### BACKGROUND

Embodiments of the description generally relate to system and method for predicting discount-demand elasticity of one or more retail items in a portfolio, and more particularly to system and method for predicting discount-demand elasticity for one or more fashion retail items on an e-commerce platform.

Pricing is one of the major strategic elements of marketing and has evolved over time. Pricing directly affects the marketing mix elements such as product features, business decisions, and promotions. The way pricing strategies are utilized will have a direct effect on purchasing decisions and thus on the success of any business. In recent years, pricing of products and services being sold online has become one of the most exciting and complex aspects in e-commerce. E-retailers are provided an unprecedented visibility into customer purchase behavior and an environment in which prices can be updated quickly and economically in response to changing market conditions. Such dynamic pricing strategies are widely used for maximizing revenue in an Internet retail channel by actively learning customers' demand response to price (price elasticity) and thus providing a rich framework for pricing projects.

However, these broad price elasticity-based strategies do not take into account discount-based elasticity. Assuming delta demand to be constant, products having the same selling price, but different discount delta (different mrp delta) will have different discount-elasticity. Whereas, their price-elasticity of demand will be same if their selling price has changed by same amount.

Therefore, there is a need for systems and methods that provide for predicting discount-demand elasticity values that can be used in pricing strategies. Moreover, it may be desirable to develop discount strategy at an individual retail item/style level for an entire portfolio/catalogue while maximizing on a given sales target for the portfolio/catalogue.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description. Example embodiments provide systems and methods to

Briefly, according to an example embodiment, a system for predicting discount-demand elasticity of one or more retail items in a portfolio is presented. The system includes a feature engineering module configured to generate a plurality of features based on historical data of a plurality of retail items in the portfolio. The system further includes an elasticity estimator configured to estimate discount-demand elasticity values for the plurality of retail items in the portfolio; and an elasticity-band generator configured to generate a set of elasticity bands for the plurality of retail items based on the estimated discount-demand elasticity values. The system furthermore includes a training module configured to train a classification model based on the generated plurality of features and the generated set of elasticity bands. The system moreover includes an elasticity prediction module configured to generate discount-demand elasticity of the one or more retail item in the portfolio from the trained classification model.

According to another example embodiment, a method for predicting discount-demand elasticity of one or more retail items in a portfolio is presented. The method includes the step of generating a plurality of features based on historical data of a plurality of retail items in the portfolio. The method further includes the steps of estimating discount-demand elasticity values for the plurality of retail items in the portfolio, and generating a set of elasticity bands for the plurality of retail items based on the estimated discount-demand elasticity values. The method furthermore includes the steps of training a classification model based on the generated plurality of features and the generated set of elasticity bands; and generating discount-demand elasticity of the one or more retail items in the portfolio from the trained classification model.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram illustrating a system for predicting discount-demand elasticity of one or more retail item in a portfolio, according to some aspects of the present description,

FIG. 2 is a block diagram illustrating a system for collecting data for discount-demand elasticity prediction of one or more retail item in a portfolio, according to some aspects of the present description,

FIG. 3 is a block diagram illustrating a system for predicting discount-demand elasticity of one or more retail item in a portfolio, according to some aspects of the present description,

FIG. 4 is a table showing rules for classifying discount-demand elasticity values into a set of elasticity bands, according to some aspects of the present description,

FIG. 5 is a table showing assigned adjustment values for the set of elasticity band, according to some aspects of the present description; and

FIG. 6 is a flow chart illustrating a method for predicting discount-demand elasticity of one or more retail items in a portfolio, according to some aspects of the present description.

### DETAILED DESCRIPTION OF EXAMPLE EMBODIMENTS

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Example embodiments of the present description present systems and methods for predicting discount-demand elasticity of one or more retail items in a portfolio.

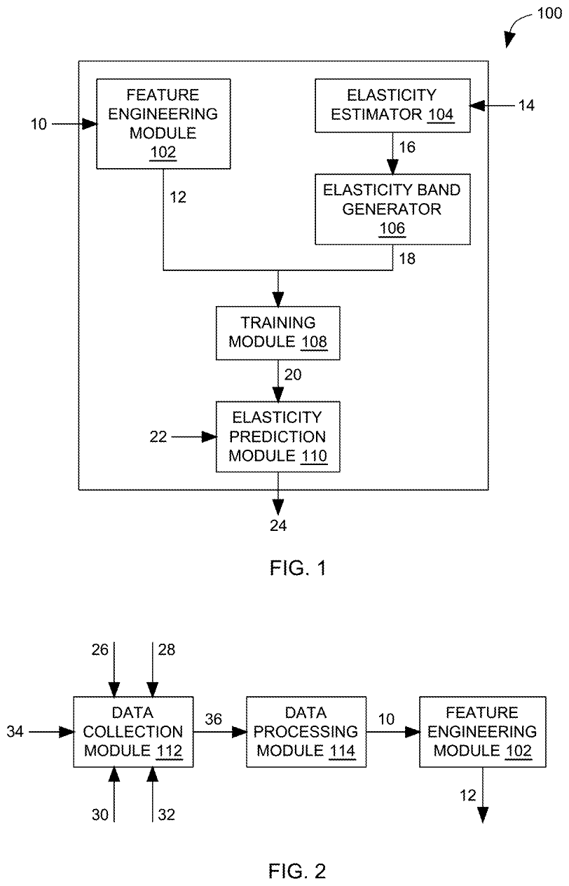

FIG. 1 is a block diagram of a system 100 for predicting discount-demand elasticity of one or more retail items in a portfolio. The system 100 includes a feature engineering module 102 configured to generate a plurality of features 12 based on historical data 10 of a plurality of retail items in the portfolio. The system 100 further includes an elasticity estimator 104 configured to estimate discount-demand elasticity values 16 for the plurality of retail items in the portfolio; and an elasticity-band generator 106 configured to generate a set of elasticity bands 18 for the plurality of retail items based on the estimated discount-demand elasticity values 16. The system 100 furthermore includes a training module 108 configured to train a classification model based on the generated plurality of features 12 and the generated set of elasticity bands 18. The system 100 moreover includes an elasticity prediction module 110 configured to generate discount-demand elasticity 24 of the one or more retail item in the portfolio from the trained classification model 20. These system components are described in further detail below.

The term “portfolio” as used herein refers to a defined collection of retail items. Non-limiting examples of retail items include fashion retail items, furniture items, decorative items, linen, furnishing (carpets, cushions, curtains), lamps, tableware, and the like. In one embodiment, the portfolio is a collection of fashion retail items. Non-limiting examples of fashion retail items include garments (such as top wear, bottom wear, and the like), accessories (such as scarves, belts, socks, sunglasses, bags), jewellery, foot wear and the like. For the purpose of this description, the following embodiments are described with respect to an online fashion retail platform. However, it must be understood that embodiments described herein can be implemented on any e-commerce platform having a portfolio of retail items.

The portfolio may be defined based on metrics and/or organizational structure of the retailer. For example, the portfolio may be defined based on individual departments within the retail organization. In some example embodiments, the portfolio may be segregated based on the gender and categories of the fashion retail items. For example, in an example embodiment, the portfolio may include all men's shirts. In another example, the portfolio may include all women's footwear.

It should be noted that the term “retail item” as used herein refers to a particular “style” of the “retail item” within the portfolio. For example, for a portfolio including all men's shirts, the term “plurality of retail items” refers to the different style of shirts (varying by brand, design, color etc.) available in the portfolio. As each retail item (e.g., a shirt) will be available at different sizes, the term “retail item” encompasses all the sizes for a particular style (e.g., shirt of a particular brand with a particular design and color). Similarly, for a portfolio including all women's shoes, the term “plurality of retail items” refers to the different products, such as, sandals, boots etc. (varying by style, brand, design, color etc.) available in the portfolio.

Referring again to FIG. 1, the feature engineering module 102 is configured to generate a plurality of features based on historical data of a plurality of retail items in the portfolio. It should be noted that the term “plurality of retail items” may either refer to all the retail items in the portfolio or a subset of the retail items in the portfolio. For example, for a portfolio including men's shirts, either the data for the entire portfolio of men's shirts may be used for feature engineering and training the model, or the data for a subset of the men's shirts portfolio may be used for feature engineering and training the model. In some embodiments, the historical data includes product attributes, sales data, pricing data, inventory data, and visibility data aggregated for the plurality of retail items on a daily basis.

The system 100, in some embodiments, may further include a data collection module 112 and a data processing module 114, as shown in FIG. 2. The data collection module 112 is configured to collect historical data such as product attributes 26, sales data 28, pricing data 30, inventory data 32, and visibility data 34. Non-limiting examples of product attributes 26 include style id, style name, article type, master category, sub-category, gender, season code, season, business unit, age group, color, article number, brand type, and the like. Non-limiting examples of sales data 28 include quantity sold, returns received, live status, live stock keeping unit (sku) count, non-live sku count, average inventory age and the like. Non-limiting examples of pricing data 30 includes maximum retail price (mrp), average input discount, revenue, trade discount, coupon discount, tax and the like. Non-limiting examples of inventory data 32 include opening stock, closing stock, inventory count (best quality), inventory count (degraded quality), inventory count aged 0-30 days, inventory count aged 30-60 days, inventory count aged 60-90 days, inventory count aged 90+ days, and the like. Non-limiting examples of visibility data 34 include average search ranking, list views count, product detail page (pdp) views count, cart views count, click for offer count, click for offer disappointment count, unique customer list views count, unique customer pdp views count, unique customer cart views count, and the like. The collected data 36 from the data collection module 112 may be further processed (e.g., the data may be sanitized and/or outlier data such as sales days data may be removed). by the data processing module 114 to generate historical data 10, which is provided as an input to the feature engineering module 102.

The feature engineering module 102 is configured to generate a plurality of features 12 from the historical data 10, wherein the features 12 are used to generate mock data that is provided as an input to the training module 108, described in detail later. The plurality of features 12 may be generated based on pricing-based variables, visibility-based variables, inventory-based variables, product-based variables and the like. These variables may be generated based on existing style, day level variables of previous day. In some embodiments, the plurality of features 12 may also include competitive features at a brand level. Pricing and visibility-based variables may be used to generate the competitive features in such instances. In some embodiments, the feature engineering nodule 102 is configured to generate the plurality of features 12 based on the style, day level features for the styles which got sold in the last two weeks.

Referring again to FIG. 1, the system 100 further includes an elasticity estimator 104 configured to estimate discount-demand elasticity values 16 for the plurality of retail items in the portfolio. The elasticity estimator 104 is configured to estimate the discount-demand elasticity values 16 based on the sales and pricing data 14, sorted at a date level, for the plurality of retail items.

The term “discount-demand elasticity” is a measure of the change in quantity demanded in relation to its discount change. The discount demand elasticity may be estimated using the following equations (1)-(3):

Discount demand elasticity=Percentage Change in Quantity sold (PCQ)/Percentage Change in Trade discount (PCT) (1)

Percentage Change in Quantity sold (PCQ)=(Quantity sold at day T−Quantity sold at day T−1)/(Quantity sold at day T−1) (2)

Percentage Change in Trade discount (PCT)=(Trade discount at day T−Trade discount at day T−1)/(Trade discount at day T−1). (3)

The system 100 further includes an elasticity band generator 106 configured to estimate a set of elasticity bands 18 for the plurality of retail items based on the estimated discount-demand elasticity values 16. In some embodiments, the elasticity band generator 106 is configured to generate the set of elasticity bands 18 based on the estimated discount-demand elasticity values 16 and a median estimated discount-demand elasticity value.

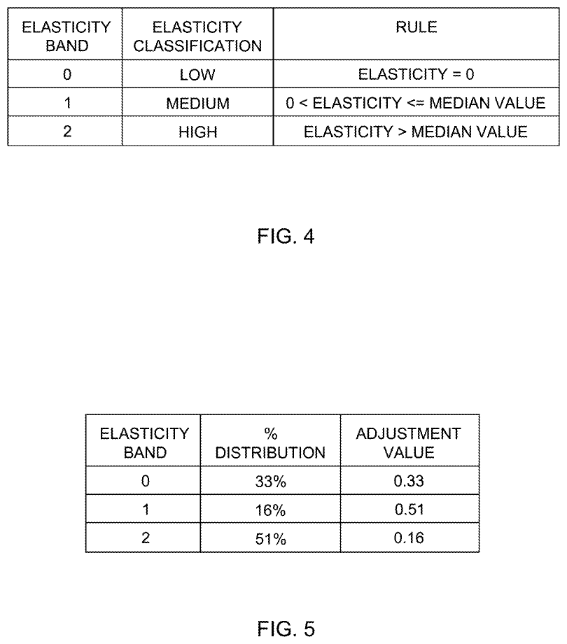

The elasticity-band generator 106 may be further configured to generate the set of elasticity bands 18 that classify the plurality of retail items as having low elasticity, medium elasticity and high elasticity. In such instances, the elasticity-band generator 106 may be configured to classify the plurality of retail items into elasticity bands 18 based on the rules specified in FIG. 4. In the example embodiment shown in FIG. 4, the plurality of retail items having elasticity value of 0 may be classified as having low elasticity (elasticity band=0). Further, the plurality of retail items having an elasticity value greater than 0 but less than or equal to the median value may be classified as having medium elasticity (elasticity band=1), and the plurality of retail items having an elasticity value greater than the median value may be classified as having high elasticity (elasticity band=2).

In some embodiments, some of the retail items of the plurality of retail items may not have any sale data for T & T−1 days because these retail items may not be sold on these days. In such instances, these retails items may be incorrectly classified as having low elasticity based on the methodology described herein. In such instances, the elasticity band generator 106, according to embodiments of the present description, instead classifies these retail items based on the average (mode) elasticity at the brand, article, gender (BAG) price level. That is, the average elasticity value for the same article (e.g., shirts), for the same gender (e.g., men's), for the same brand (e.g., Polo™), and at the same price (e.g., Rs 599) is used for classification of such retail items. If the BAG price level elasticity doesn't exist then BAG (brand, article, gender) level average elasticity may be used. If BAG level average elasticity doesn't exist then AG price (article, gender, price) level elasticity may be used, and if that also doesn't exist then AG (article, gender) level elasticity may be used.

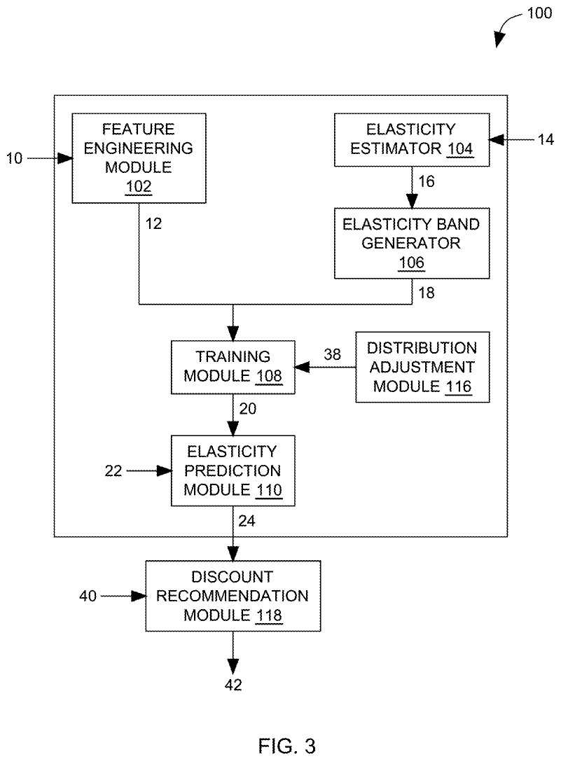

Further, for instances where the bands are un-equally distributed across the plurality of retail items, the system 100 may additionally include a distribution adjustment module 116, as shown in FIG. 3. The distribution adjustment module 116 is configured to adjust the distribution of the plurality of retails items across the set of elasticity bands 18 by assigning a corresponding adjustment value 38 to each elasticity band in the set of elasticity bands 18. FIG. 5 illustrates an example embodiment, where adjustment values 38 are assigned to the set of elasticity bands 18 based on the distribution of the plurality of retail items across the set of elasticity bands 18.

Referring again to FIG. 1, the system 100 further includes a training module configured to train a classification model based on the generated plurality of features 12 and the generated set of elasticity bands 18 for the plurality of retail items. Non-limiting example of a suitable classification model includes a random forest classifier model. In an example embodiment, all the data except last week's data may be used for training while the last week's data may be used for validation.

In embodiments including a distribution adjustment module 116, the training module 108 is further configured to train the classification model based on the assigned adjustment values 38 (as shown in FIG. 3).

In some embodiments, the classification model may be trained iteratively by dropping the least important features in each iteration. In such instances, the training module 108 may be further configured to generate a set of optimized features along with the trained classification model. These set of optimized features may be used for predicting the discount-demand elasticity value 24 using the trained classification model 20 by the elasticity prediction module 110. As noted earlier, the elasticity prediction module 110 is configured to generate discount-demand elasticity 24 of the one or more retail item in the portfolio from the trained classification model 20, based on discount data 22 for the one or more retail item on an hourly basis.

Referring now to FIG. 3, the system 100 may further include a discount recommendation module 118, in some embodiments. The discount recommendation module 118 is configured to recommend a discount value 42 for the one or more retail item based on the generated discount-demand elasticity 24 and a sales target 40 for the portfolio. The sales target 40 may be provided by the retailer or an individual business unit of the retailer. The sales target 40 for the portfolio may include a revenue target for the portfolio, a gain margin target for the portfolio, or both.

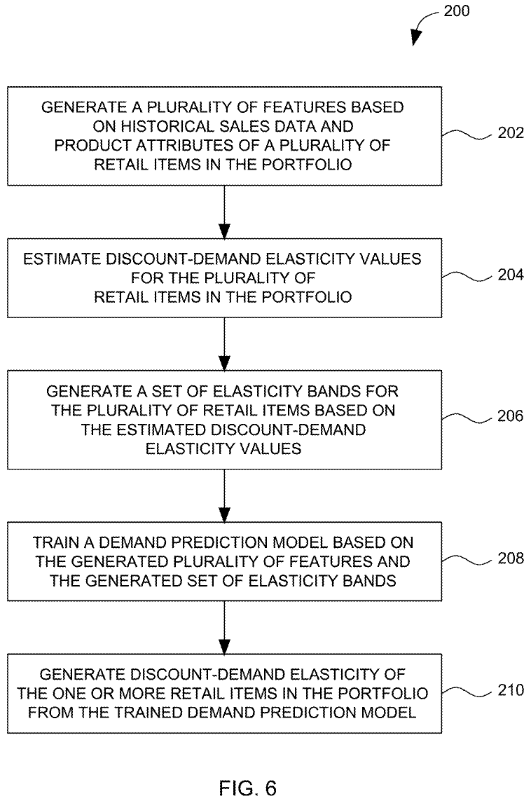

FIG. 6 is a flowchart illustrating a method 200 for optimizing prices of a plurality of retail items in a portfolio. The method 200 may be implemented using the systems of FIGS. 1-3, according to some aspects of the present description. Each step of the method 200 is described in detail below.

The method 200 includes, at step 202, generating a plurality of features 12 based on historical data 10 of a plurality of retail items in the portfolio. The historical data 10 may include product attributes, sales data, pricing data, inventory data, and visibility data aggregated for the plurality of retail items on a daily basis. Non-limiting examples of suitable historical data 10 are described herein earlier. In some embodiments, the method 200 may further include the steps of data collection and data processing (e.g., sanitizing the data and/or removing outlier data such as sales days data etc.) to generate the historical data 10 that is used for feature engineering.

The plurality of features 12 may be generated based on pricing-based variables, visibility-based variables, inventory-based variables, inventor-based variables, product-based variables and the like. These variables may be generated based on existing style, day level variables of previous day. In some embodiments, the plurality of features 12 may also include competitive features at a brand level. Pricing and visibility-based variables may be used to generate the competitive features in such instances. In some embodiments, step 202 includes generating the plurality of features 12 based on the style, day level features for the styles which got sold in the last two weeks.

The method further includes, at step 204, estimating discount-demand elasticity values 16 for the plurality of retail items in the portfolio. The discount-demand elasticity values 16 may be estimated based on the sales and pricing data 14, sorted at a date level, for the plurality of retail items. Equations (1)-(3), described herein earlier, are used for estimating the discount-demand elasticity values in accordance with some embodiments.

These estimated discount-demand elasticity values are used for generating a set of elasticity bands for the plurality of retail items, at step 206. The set of elasticity bands may be generated based on the estimated discount-demand elasticity values and a median estimated discount-demand elasticity value. Step 206 may further include classifying the plurality of retail items as having low elasticity, medium elasticity and high elasticity, based on the rules specified in FIG. 4. In the example embodiment shown in FIG. 4, the plurality of retail items having elasticity value of 0 may be classified as having low elasticity (elasticity band=0). Further, the plurality of retail items having an elasticity value greater than 0 but less than or equal to the median value may be classified as having medium elasticity (elasticity band=1), and the plurality of retail items having an elasticity value greater than the median value may be classified as having high elasticity (elasticity band=2).

In some embodiments, some of the retail items of the plurality of retail items may not have any sale data for T & T−1 days because these retail items may not be sold on these days. In such instances, these retails items may be incorrectly classified as having low elasticity based on the methodology described herein. In such instances, step 206 may include classifying these retail items based on the average (mode) elasticity at either the brand, article, gender (BAG) price level, at the BAG (brand, article, gender) level, at the AG price (article, gender, price) level, or at the AG (article, gender) level.

Further, for instances where the bands are un-equally distributed across the plurality of retail items, the method 200 may further include adjusting the distribution of the plurality of retails items across the set of elasticity bands by assigning a corresponding adjustment value 38 to each elasticity band in the set of elasticity bands 18. FIG. 5 illustrates an example embodiment, where adjustment values 38 are assigned to the set of elasticity bands 18 based on the distribution of the plurality of retail items across the set of elasticity bands 18.

Referring back to FIG. 6, the method 200 further includes, at step 208, training a classification model based on the generated plurality of features 12 and the generated set of elasticity bands 18. Non-limiting example of a suitable classification model includes a random forest classifier model. In an example embodiment, all the data except last week's data may be used for training purpose while the last week's data may be used for validation. In some embodiments, step 208 may further include training the classification model based on the assigned adjustment values 38 (as shown in FIG. 5).

In some embodiments, the classification model may be trained iteratively by dropping the least important features in each iteration. In such instances, step 208 may further include generating a set of optimized features along with the trained classification model. These set of optimized features may be used for predicting the discount-demand elasticity value 24 using the trained classification model 20 in step 210. The discount-demand elasticity 24 may be generated from the trained classification model 20, based on discount data for the one or more retail item on an hourly basis.

The method 200 may further include a step of recommending a discount value 42 for the one or more retail item based on the generated discount-demand elasticity 24 and a sales target 40 for the portfolio. As noted earlier, the sales target 40 for the portfolio may include a revenue target for the portfolio, a gain margin target for the portfolio, or both

Systems and methods of the present description, provide for predicting discount demand elasticity for styles/products having sparse data or no sales data (e.g., new style/products) by comparing their characteristics with respect to existing products. Specifically, by building the model at a category level, the problems with sparseness of data is mitigated as the characteristics of all the styles/products are captured for different periods of time. Moreover, by using elasticity bands instead of absolute elasticity values, all the different categories are classified using a simplified criterion, which allows for use of the same trained classification model across different categories (e.g., shirts versus bags etc.).

Further, in accordance some embodiments of the present description, revenue and margin goal targets can be achieved at an intra-day level by using elasticity at varying discount levels. For example, for increasing revenues, retail items having high elasticity (i.e., elasticity band=2) may be further discounted to drive more sales and revenues. Similarly, for increasing margins, the retail items with lower elasticity (i.e., elasticity band=0) may be sold at the mrp or low discount rates to drive higher margins. Accordingly, revenue and margin goals can be targeted on an intra-day basis, giving better control over meeting revenue and margin targets.

Moreover, systems and methods according to embodiments of the present description may further provide detailed understanding of discount-demand elasticity at a style level, at a brand level, or at a category (e.g., shirts vs. pants) level. Therefore, it may be easy to identify non performing styles and their demand could be estimated at different discount points. Hence stock clearance and date of holding could be optimized. Further, systems and methods of the present description may provide for planning of product assortment at a brand level by providing detailed brand-level elasticity recommendation. Similarly, detailed category-level elasticity recommendation may help in prioritizing significant categories and boosting negligent categories. By comparing the elasticity of different brands, a particular brand may also be promoted by assigning the appropriate discount values.

The system(s), described herein, may be realized by hardware elements, software elements and/or combinations thereof. For example, the modules and components illustrated in the example embodiments may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or more software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

While only certain features of several embodiments have been illustrated, and described herein, many modifications and changes will occur to those skilled in the art. It is, therefore, to be understood that the appended claims are intended to cover all such modifications and changes as fall within the scope of the invention and the appended claims.

1. A system for predicting discount-demand elasticity of one or more retail items in a portfolio, the system comprising:
a feature engineering module configured to generate a plurality of features based on historical data of a plurality of retail items in the portfolio;
an elasticity estimator configured to estimate discount-demand elasticity values for the plurality of retail items in the portfolio;
an elasticity-band generator configured to generate a set of elasticity bands for the plurality of retail items based on the estimated discount-demand elasticity values;
a training module configured to train a classification model based on the generated plurality of features and the generated set of elasticity bands; and
an elasticity prediction module configured to generate discount-demand elasticity of the one or more retail item in the portfolio from the trained classification model.

2. The system of claim 1, wherein the historical data comprises product attributes, sales data, pricing data, inventory data, and visibility data aggregated for the plurality of retail items on a daily basis.

3. The system of claim 1, wherein the elasticity band generator is configured to generate the set of elasticity bands based on the estimated discount-demand elasticity values and a median estimated discount-demand elasticity value.

4. The system of claim 1, wherein the elasticity-band generator is configured to generate the set of elasticity bands that classify the plurality of retail items as having low elasticity, medium elasticity and high elasticity.

5. The system of claim 1, further comprising a distribution adjustment module configured to adjust the distribution of the plurality of retails items across the set of elasticity bands by assigning a corresponding adjustment value to each elasticity band in the set of elasticity bands.

6. The system of claim 5, wherein the training module is further configured to train the classification model based on the assigned adjustment values.

7. The system of claim 1, wherein the elasticity prediction module is configured to generate discount-demand elasticity of the one or more retail item in the portfolio from the trained classification model, based on discount data for the one or more retail item on an hourly basis.

8. The system of claim 1, further comprising a discount recommendation module configured to recommend a discount value for the one or more retail item based on the generated discount-demand elasticity and a sales target for the portfolio.

9. The system of claim 8, wherein the sales target comprises a revenue target for the portfolio, a gain margin target for the portfolio, or both.

10. A method for predicting discount-demand elasticity of one or more retail items in a portfolio, the method comprising:
generating a plurality of features based on historical data of a plurality of retail items in the portfolio;
estimating discount-demand elasticity values for the plurality of retail items in the portfolio;
generating a set of elasticity bands for the plurality of retail items based on the estimated discount-demand elasticity values;
training a classification model based on the generated plurality of features and the generated set of elasticity bands; and
generating discount-demand elasticity of the one or more retail items in the portfolio from the trained classification model.

11. The method of claim 10, wherein the historical data comprises product attributes, sales data, pricing data, inventory data, and visibility data aggregated for the plurality of retail items on a daily basis.

12. The method of claim 10, comprising generating the set of elasticity bands based on the estimated discount-demand elasticity values and a median estimated discount-demand elasticity value.

13. The method of claim 10, further comprising classifying the plurality of retail items as having low elasticity, medium elasticity and high elasticity based on the generated set of elasticity bands.

14. The method of claim 10, further comprising adjusting the distribution of the plurality of retails items across the set of elasticity bands by assigning a corresponding adjustment value to each elasticity band in the set of elasticity bands.

15. The method of claim 14, further comprising training the classification model based on the assigned adjustment values.

16. The method of claim 10, comprising generating the discount-demand elasticity of the one or more retail item in the portfolio from the trained classification model, based on discount data for the one or more retail item on an hourly basis.

17. The method of claim 10, further comprising recommending a discount value for the one or more retail item based on the generated discount-demand elasticity and a sales target for the portfolio.

18. The method of claim 17, wherein the sales target comprises a revenue target for the portfolio, a gain margin target for the portfolio, or both.
